(19) United States
(12) Patent Application Publication
(10) Pub. No.: US 2007/0247729 A1
(43) Pub. Date: Oct. 25, 2007

(54) Reflective objective

(75) Inventors: David Vaughnn, Edina, MN (US); Ronald E. Gerber, Richfield, MN (US)

Correspondence Address: DICKE BILLIG & CZAJA, PLLC;ATTN: CHRISTOPHER MCLAUGHLIN, 100 SOUTH FIFTH STREET, SUITE 2250, MINNEAPOLIS, MN, 55402, US

(73) Assignee: Rudolph Technologies, Inc.

(21) Appl. No.: 11/411,217

(22) Filed: Apr. 25, 2006

(51) Int. Cl. G02B 5/10

(52) U.S. Cl. 359/853; 359/834

(57) ABSTRACT

A reflective objective is disclosed, in which essentially all the optical power is in a single, off-axis, concave mirror, which is oriented generally perpendicular to the central axis of the objective. An incident beam is directed to and from the concave mirror by a pair of flat mirrors, so that a central on-axis ray in the incident beam is collinear with the corresponding thrice-reflected ray at the object. The object is one focal length away from the concave mirror. The aperture stop is also one focal length away from the concave mirror, leading to a condition of telecentricity at the object. Different focal lengths for the objectives are realized by using mirrors with different curvatures, located at different distances away from the central axis of the objective. The reflective objective can optionally be retrofitted into a turret typically used for microscope objectives, and can optionally have refractive elements, making the objective catadioptric.

### TECHNICAL FIELD OF THE INVENTION

The present invention is directed to reflective objectives.

### BACKGROUND OF THE INVENTION

A typical visual inspection system may be similar in function to a microscope, but may have more demanding requirements on its imaging properties. For instance, a visual inspection system may require a particular degree of uniformity, so that a particular feature on the object appears the same, regardless of its location in the field of view. Many of these demanding requirements for the system become, in turn, demanding requirements for the objective, which is the optical component closest to the object.

In many cases, a typical all-refractive objective that is suitable for a microscope may have shortcomings if used in a visual inspection system. Five of these possible shortcomings are listed below:

(1) The objective may be non-telecentric.

Telecentricity, which is highly desirable in a visual inspection system, may be described by the following condition: A central ray (meaning a ray passing through the center of the pupil) at the edge of the field of view emerges parallel to a central ray at the center of the field of view. In other words, in a telecentric inspection system, the cone of illuminating rays strikes the object with the same orientation, for all locations within the field of view. Note that telecentricity may be less important for a microscope system, in which the object of interest may be manually moved into the center of the field of view.

For an infinity-corrected system (meaning one where the objective may be illuminated with nominally collimated incident light, the object is located nominally at the front focal plane of the objective, and the light returning from the objective is nominally collimated), telecentricity may be achieved if the aperture stop of the objective is located at the rear focal plane of the objective.

For the majority of off-the-shelf, refractive microscope objectives, the aperture stop is an opaque disk with a circular hole in its center, and is located fairly close to the threaded portion of the objective. In most cases, the aperture stop is the outermost element in the objective, and is easily seen through the threaded portion of the objective barrel. This location near the threads seldom corresponds to the rear focal plane of the objective, and seldom leads to a telecentric objective.

(2) The objective may be prone to “ghosts”.

These ghosts can arise from faint reflections off the multiple air-glass interfaces inside a typical microscope objective. There may be ghost images, where a bright spot in the image may produce a ghost bright spot elsewhere in the field of view. In addition, there may be ghost pupils, where the illumination pattern itself may be superimposed onto a portion of the image; for common bright-field illumination, a ghost pupil can appear as a bright circle concentric with the center of the image. These ghost pupils are more common with low magnification (or, equivalently, long focal length) objectives.

(3) The objective may have less than ideal image quality.

For instance, the objective may have residual aberrations than can degrade the image quality, such as chromatic aberration, or longitudinal chromatic aberration, which may be especially prevalent at low magnifications (or, equivalently, long focal lengths). There may be residual field curvature, which can degrade the edges of the field of view differently than the center of the field of view; this is especially undesirable in an inspection system that requires uniformity over the entire field of view. In addition, there may also be vignetting, which is an undesirable truncation of rays at a surface other than the aperture stop, which can also lead to nonuniformities over the field of view.

(4) The objective may have a wavelength-dependent bias.

A typical all-refractive objective may have anti-reflection coatings on its refractive surfaces, which are designed to reduce reflections at a particular wavelength, or over a particular wavelength range. These anti-reflection coatings may have non-uniformities outside the wavelength range or, depending on the complexity of the coatings and the curvatures of the refractive surfaces, may even produce wavelength-dependent artifacts at the edge of the field of view. These non-uniformities are all undesirable for a visual inspection system.

(5) The objective may be part of a matched set, where performance and cost vary from objective-to-objective, depending on magnification (or, equivalently, focal length).

Matched sets of microscope objectives can often be purchased, with each objective having a different magnification (or, equivalently, focal length). Each objective can be screwed into a turret that allows for selection of one of the objectives. The mechanical constraints of the turret often require that the parfocal distance (meaning the distance between the objective shoulder and the object) be the same for all objectives in the set. A rotation of the turret slides one objective out of the optical path and another into the optical path, typically with only a minimal fine adjustment of focus. This allows for a relatively simple change in magnification without significant adjustment of the microscope.

Maintaining a constant parfocal distance for an entire matched set of refractive objectives can be challenging. For instance, some focal lengths may have a relatively straightforward design, while other focal lengths in the matched set may require more refractive elements than the straightforward objective, which can increase the complexity and cost, and may even reduce the performance if it requires more anti-reflection coatings, or more severe aberration correction.

For instance, consider the following exemplary matched set of all-refractive objectives, in which the focal length of a 5× objective is relatively straightforward.

For this example, both the 2× and the 10× objective may perform more poorly than the 5×, with respect to the above four shortcomings. The 2× and 10× may also cost more than the 5×. Furthermore, the 1× and 20× may perform even more poorly than the 2× and 10×, and may cost even more than the 2× and the 10×. These are merely examples intended to show that there may be undesirable variations from objective-to-objective in a matched set, and are not intended to be limiting in any way.

Accordingly, it would be beneficial to provide an objective that can overcome one or more of these possible shortcomings.

### SUMMARY OF THE INVENTION

An embodiment is an optical apparatus having a rear focal plane and a front focal plane, comprising an off-axis reflector; and a compound reflector for reflecting light from an aperture stop to the off-axis reflector, and for reflecting light from the off-axis reflector to an object plane largely parallel to the aperture stop.

A further embodiment is an optical apparatus, comprising an optical path from an aperture stop to an object plane largely parallel to the aperture stop; and a concave reflector having a rear focal plane generally coincident with the aperture stop, and a front focal plane generally coincident with the object plane. The optical path has a first off-axis reflection between the aperture stop and the concave reflector, and has a second off-axis reflection between the concave reflector and the object plane.

A further embodiment is an optical apparatus, comprising a first objective, comprising a first off-axis reflector; and a first compound reflector for reflecting light from a first aperture stop to the first off-axis reflector, and for reflecting light from the first off-axis reflector to an object plane largely parallel to the aperture stop; and a second objective, comprising a second off-axis reflector different from the first off-axis reflector; and a second compound reflector for reflecting light from a second aperture stop to the second off-axis reflector, and for reflecting light from the second off-axis reflector to the object plane. The first and second objectives are selectable.

A further embodiment is an optical apparatus, comprising a body having a threaded portion concentric with a principal optical axis; and a compound reflector rotatably mounted to the body for diverting a beam from the principal optical axis and back to the principal optical axis. The compound reflector is azimuthally adjustable with respect to the threaded portion.

A further embodiment is an optical apparatus for use in inspecting an object at an object plane, comprising a rear focal plane; a rear optical axis normal to the rear focal plane; a front plane; a front optical axis normal to the front plane; a first reflector disposed along at least one of the rear and front optical axes primarily for providing off-axis light from at least one of the rear and front optical axes; and a second reflector primarily for establishing the rear focal plane and the front plane and disposed for receiving off-axis light from the first reflector. The rear focal plane is generally coincident with an aperture stop, and the front plane is generally coincident with the object plane.

### BRIEF DESCRIPTION OF THE DRAWINGS

FIG. 1 is a side-view plan drawing of a first embodiment of a reflective objective.

FIG. 2 is a top-view plan drawing of the reflective objective of FIG. 1.

FIG. 3 is a side-view plan drawing of a second embodiment of a reflective objective.

FIG. 4 is a side-view plan drawing of a third embodiment of a reflective objective, with a first focal length.

FIG. 5 is a side-view plan drawing of a third embodiment of a reflective objective, with a second focal length.

FIG. 6 is a top-view plan drawing of the third embodiment of a reflective objective.

FIG. 7 is a side-view cutaway drawing of a fourth embodiment of a reflective objective.

FIG. 8 is a side-view plan drawing of a catadioptric objective.

### DETAILED DESCRIPTION OF THE INVENTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

The potential shortcomings of an all-refractive objective can include any or all of non-telecentricity, ghost images and/or ghost pupils, aberrations and/or vignetting, non-uniformities with respect to wavelength, and/or variations in performance from objective-to-objective in a matched set of objectives.

One or more of these potential shortcomings may be overcome by a reflective objective, summarized in non-limiting generalities as follows. Essentially all the optical power in the objective is in a single, off-axis, concave mirror, which is oriented generally perpendicular to the central axis of the objective. An incident beam is directed to and from the concave mirror by a pair of flat mirrors, so that a central on-axis ray in the incident beam is collinear with the corresponding thrice-reflected ray at the object. The object is one focal length away from the concave mirror. The aperture stop is also one focal length away from the concave mirror, leading to a condition of telecentricity at the object. Different focal lengths for the objectives may be realized by using mirrors with different curvatures, located at different distances away from the central axis of the objective. The reflective objective can optionally be retrofitted into a turret typically used for microscope objectives, and can optionally have refractive elements, making the objective catadioptric. The above description is merely an informal summary, and is not to be construed as limiting in any way.

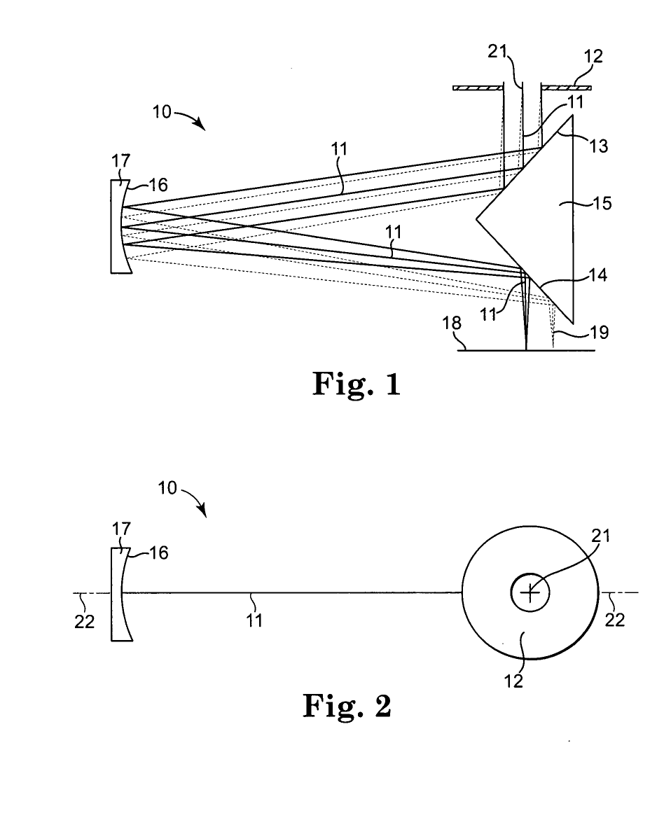

FIG. 1 shows a schematic drawing of a reflective objective 10. The aperture stop 12 is at the top of the figure, the object 18 is at the bottom of the figure, the concave mirror 17 is at the left of the figure, and the two planar mirrors 13 and 14 are shown as adjacent sides of a prism 15. The object 18 is located in the front focal plane of the mirror 17. The aperture stop 12 is located at the rear focal plane of the mirror 17, ensuring that the objective 10 is telecentric. Each of these elements is described in greater detail below.

Note that the following discussion assumes that the objective is illuminated by a source, that the source illumination is brought to a focus on or near the object, and that the light reflected from the object returns through the objective and is collected. Alternatively, the object may be illuminated from beneath, so that light transmitted through the object passes through the objective and is collected. As a further alternative, the object itself may be luminescent or fluorescent, and may emit its own light to be collected by the objective. In general, the light path through the objective is reversible, so that a light path from the aperture stop to the object is equivalent to a light path from the object to the aperture stop.

In addition, the terms “rear” and “front” are used below to refer to the focal planes of the objective, with the front focal plane facing the object, and the rear focal plane facing the illumination and detection optics. These terms are used merely for convenience, and are not intended to be limiting in any way. For instance, light may propagate from the rear side to the front side, or, equally well, from the front side to the rear side. Alternatively, the terms “rear” and “front” may be reversed.

The light in FIG. 1, both illuminating and collected, is drawn schematically as rays. Two representative bundles of rays are shown in FIG. 1—an on-axis bundle, with central ray 11, and an off-axis bundle 19. It will be understood by one of ordinary skill in the art that the actual light beams contain a generally continuous range of angles, including both the on-axis and off-axis bundles; the on-axis and off-axis bundles are drawn merely as guides for the reader. Both on-axis and off-axis bundles are essentially collimated as they pass through the aperture stop 12. Both are also focused onto the object 18, but at different locations in the field of view. Note that the condition of telecentricity ensures that at the object, the illuminating cones of light have the same angular orientation. In other words, at the object 18, the central ray in the off-axis cone 19 is parallel to the central ray 11 in the on-axis cone, and both are generally perpendicular to the aperture stop 12. Note that the bundles of rays may represent either illuminating light or reflected light, since the paths through the optical system are generally reversible. The bundles of rays may be collectively known as simply a “beam”.

As drawn in FIG. 1, the objective 10 is “infinity corrected”, meaning that the objective 10 is illuminated with nominally collimated incident light, the object 18 is located nominally at the front focal plane of the objective 10, and the light returning from the objective 10 is nominally collimated. This condition is also known as operating at infinite conjugates.

Alternatively, the objective 10 may operate at finite conjugates, meaning that the incident and returning beams may be non-collimated. At finite conjugates, the objective is illuminated with diverging or converging light. The illumination comes to a focus at a front plane; note that if the illumination is collimated, then the front plane coincides with the front focal plane. The object is located generally at the front plane. For telecentricity, the aperture stop may still be located at the rear focal plane of the objective.

An incident beam enters the objective 10 through the aperture stop 12. The aperture stop may be an opaque screen made of metal or plastic, with a suitable opening for the pupil of the objective. Typically, for bright field illumination and bright field collection, the aperture stop 12 may be an opaque annulus with a transparent center, or, more simply, a round hole. For other illumination or collection schemes, a suitably shaped aperture stop 12 may be used. The size of the aperture stop 12 may be of interest when designing the illumination optics, which typically supply generally uniform illumination to the full spatial extent of aperture stop 12, with a prescribed angular extent. The center of the aperture stop 12 is denoted by element 21. An on-axis ray passing through the center 21 of the aperture stop 12 determines a “central axis” for the objective 10, which extends generally perpendicular to the aperture stop 12, from the aperture stop 12 to the object 18.

The beam reflects off a mirror 13 and is directed generally laterally away from the central axis of the objective. The mirror 13 may be a side of a compound reflector, or may optionally be a stand-alone element. For example, as drawn in FIG. 1, the mirror 13 may be one side of a special, non-refractive compound reflector, which may be located on one of the external faces of a prism. The mirror 13 may have a high-reflectivity coating, such as gold or aluminum, and/or may have a high-reflectivity thin film stack that is designed for the appropriate range of incident angles and wavelengths. The mirror 13 may be nominally planar, to within typical manufacturing tolerances, or may have some additional curvature that changes the curvature of the reflected beam. The mirror 13 may also have some diffractive features, such as a grating, that can split off part of the beam for monitoring or additional measurements; the beam path shown in FIG. 1 is for the zeroth reflected order, which has no spatial dependence on wavelength.

The beam then strikes a concave mirror 17. As drawn in FIG. 1, the concave mirror 17 has a highly reflective rear surface 16. Alternatively, the mirror 17 may have its reflective surface on the back of the mirror; for this discussion, we refer to the rear surface as highly reflective, although it will be understood that the back surface may be the highly reflective side of the mirror, and then the mirrored surface would actually be convex. The concave mirror 17 may be made from glass, metal, or any other suitable substrate. The highly reflective rear surface 16 may have a coating similar to that of mirror 13, or any other suitable high-reflectivity coating. The rear surface 16 has a particular radius of curvature equal to twice its focal length (for air incidence).

The rear surface 16 may additionally have an aspheric and/or conic component that may reduce spherical aberration at the object 18. The optional aspheric and/or conic component may be realized in the reflective surface description as a non-zero conic constant and/or one or more non-zero even aspheric coefficients. For instance, if the reflective surface is a parabola, then one way to mathematically describe the surface is with a conic constant of −1 and all the even aspheric coefficients equal to zero; its radius of curvature is typically set equal to twice the desired focal length of the objective.

The required clear aperture of the rear surface 16 may be greater than or equal to the diameter of the aperture stop 12 plus half of the full field of view at the object 18. This value may increase slightly for larger off-axis reflection angles from the mirror 17.

After reflecting from the concave mirror 17, the beam reflects off a mirror 14 and is directed toward the object 18. The mirror 14 may be similar in construction to mirror 13, and may be either integrated with mirror 13 as adjacent sides of a prism 15, or may be a separate element from mirror 13. The reflective coating of mirror 14 may be similar to that used on mirror 13, although any suitable coating may be used.

Note that the prism 15 may be referred to as a compound reflector. A compound reflector, as used in this document, is intended to mean a component that has two or more reflective sides. A prism may therefore be a compound reflector. A prism, on which the reflections are internal, rather than external as shown in FIG. 1, may also be a compound reflector. Likewise, two mirrors may also be a compound reflector, and the mirrors may be integrated or may be distinct. Similarly, a mirror and a prism may be a compound reflector.

Note that the on-axis central ray 11, which passes through the center 21 of the aperture stop, is generally collinear both before and after the three reflections shown in FIG. 1. This ray defines a central axis for the objective 10, which is generally perpendicular to both the aperture stop 12, and extends from the center of the aperture stop 12 to the object 18. Alternatively, the on-axis central ray may be laterally displaced upon reaching the object 18, so that the on-axis central ray at the aperture stop need not be collinear with the on-axis central ray at the object.

Note that the object 18 need not be parallel to the aperture stop 12, but may be inclined by several degrees or more in any direction. A tilted object plane can remain in focus throughout if the corresponding image plane is also tilted; the appropriate tilt orientations and angles are related by the so-called Scheimpflug condition. For the purposes of this document, a statement that the object plane is largely parallel to the aperture stop shall mean that the object plane may be inclined by a few degrees or more, according to the so-called Scheimpflug condition, and that a camera or viewing screen located at the image plane may also be inclined according to the so-called Scheimpflug condition so that the tilted object plane remains in focus throughout on the tilted image plane.

FIG. 2 shows the objective 10 of FIG. 1, looking “down” on the objective. The aperture stop 12 faces the viewer in FIG. 2, with its center 21. The concave mirror 17 is at the left of the figure, with on-axis central ray 11 traveling to the left before reflecting off the concave mirror 17, and to the right after reflection.

The objective 10 is said to have an azimuthal orientation, where its azimuthal angle is defined as the angle between the on-axis central ray 11 and the preferred polarization axis 22; in FIG. 2, this angle is zero. The preferred polarization axis is defined by components that are found outside of the objective in the microscope or visual inspection system, including but not limited to, one or more sources, one or more beamsplitters, and one or more detectors. The performance of any or all of these components may have a dependence on the direction of polarization, with one polarization orientation having a different transmission than a different orientation. As a result, if the on-axis central ray 11 is coincident with the preferred polarization axis 22, transmission through the system is maximized and the camera or detector in the inspection system sees the brightest image. As the azimuthal angle departs from zero, the apparent brightness of the image decreases. The actual orientation of the preferred polarization axis 22 will vary from system to system, but will be readily apparent to one of ordinary skill in the art.

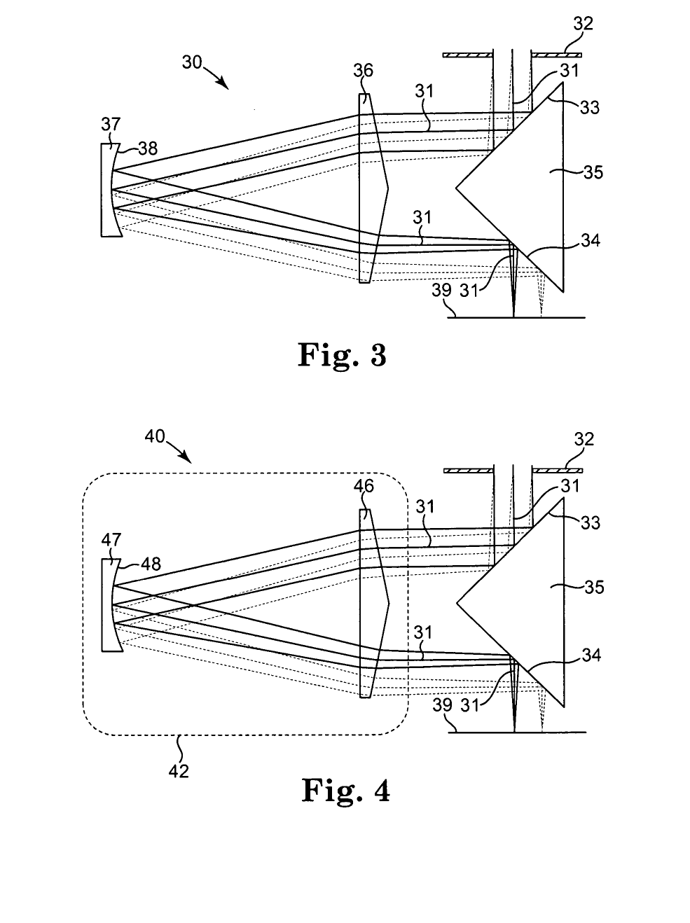

FIG. 3 shows an objective 30 in which the mirrors 33 and 34 of the compound reflector 35 are oriented at essentially 90 degrees with respect to each other, so that a central on-axis ray 31 travels essentially perpendicular to the central axis of the objective after reflecting off the mirror 33. In contrast, note that in FIG. 1, the angle between the mirrors 13 and 14 is slightly larger than 90 degrees, so that the central on-axis ray 11 has a slight incline toward the object 18 after reflecting from the mirror 13. The geometry of FIG. 3 may allow greater flexibility when adjusting for different focal lengths.

Note that in FIG. 1, the optical paths to and from the concave mirror 17 have a slight longitudinal component. For the purposes of this document, a statement that the reflections to and from the off-axis reflector are largely parallel to the aperture stop shall mean that they may or may not have a slight longitudinal component, and may refer to either the geometry of FIG. 1 or FIG. 3.

An addition to the optical path, compared with the geometry of FIG. 1, is a compound wedge 36. The wedge 36 bends the central on-axis ray 31 slightly toward the object before it encounters the curved mirror 37, with reflective surface 38. After reflection from the curved mirror 37, the central on-axis ray 31 is bent by the wedge 36 to again be essentially perpendicular to the central axis of the objective. The wedge 36 may be made as a single compound wedge, as shown in FIG. 3, or may be two distinct wedges. The wedge 36 may be made from any suitable optical material, such as glass or plastic, and may be anti-reflection coated on both sides. The orientation of the wedge 36 may be reversed, left-to-right, but it is preferable to not have a normally incident reflection from any of the wedge surfaces, in order to reduce stray reflections in the optical system. Alternatively, the wedge may be achromatized, using two sequential wedge elements of two different glass types. The two different glass types have different dispersions, and when used together to form an achromatic wedge, can ensure that the beam deviation is roughly the same over a particular band of wavelengths.

The aperture stop 32, mirror 37 with highly reflective surface 38, and object 39 may be similar in size, function and construction to analogous components in FIG. 1.

There is one small difference between the mirror 37 and the mirror 17. If the objectives 10 and 30 have comparable focal lengths and parfocal distances, then the angle at which the central on-axis ray strikes the mirror is slightly larger for the geometry of FIG. 3 than for FIG. 1. In other words, the curved mirror 37, which used a 90-degree compound reflector and a wedge, operates slightly farther off-axis than the curved mirror 17, which does not use a wedge. For focal lengths greater than a few hundred mm, this difference in nominal off-axis angle becomes relatively insignificant, and the nominal off-axis angle of the mirror becomes essentially the same, regardless of whether or not a wedge is used.

FIG. 4 shows an objective 40 that uses the basic geometry of FIG. 3, but with an interchangeable unit 42. The interchangeable unit 42 includes the compound wedge 46 and the concave mirror 47 with reflective surface 48. By swapping out both the wedge and the mirror, the focal length of the objective may be changed without significantly disturbing the aperture stop 32, the compound reflector 35, or the object 39.

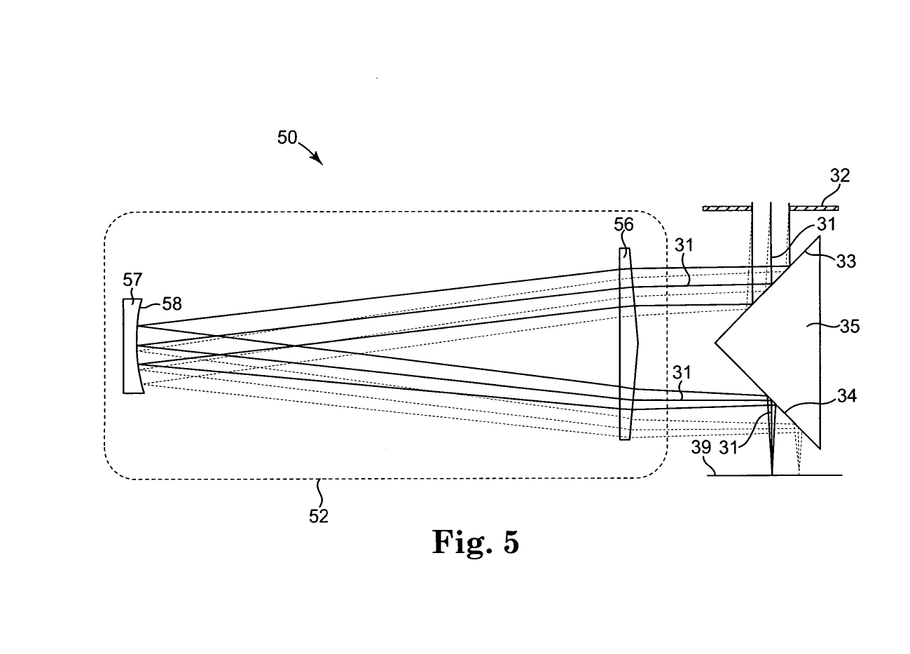

For comparison, FIG. 5 shows an objective 50, where the interchangeable unit 52 provides a longer focal length than interchangeable unit 42. The mirror 57 has a longer focal length than mirror 47, meaning that the radius of the curved surface 58 is larger than that of curved surface 48 (i.e., mirror 57 is less steeply curved than mirror 47). The compound wedge 56 has less of a wedge angle than wedge 46.

FIGS. 4 and 5 show a geometry where the mirror and wedge fomm an interchangeable unit, while the compound reflector remains essentially stationary. There may be several interchangeable units for a particular inspection system, corresponding to different focal lengths (or, equivalently, different magnifications.) For instance, there may be five different interchangeable units, with focal lengths corresponding to magnifications of 1×, 2×, 5×, 10× and 20×. For this example, the 1× interchangeable unit has a focal length twenty times longer than that of the 20× unit.

The interchangeable units may be sold or packaged as a matched set, in a similar manner to refractive objectives. Unlike matched all-refractive objectives, which can show a deterioration in performance and/or an increase in cost as the focal length departs significantly from half the parfocal distance, the performance and/or cost of the reflective objectives may be essentially the same across all in the set. The major difference across the set of reflective objectives are (1) a different mirror curvature, (2) a different path length, and (3) a different wedge angle. None of these three differences significantly affects performance and/or cost, compared with the equivalent all-refractive objective that may require adding or removing glass elements to achieve a desired performance and/or cost.

In addition, the symmetry of the geometry of FIGS. 4 and 5 ensures two simultaneous conditions: (1) the object is located generally at the front focal plane of the mirror, and (2) the aperture stop is located generally at the rear focal plane of the mirror. Condition (2) ensures that the objectives 40 and 50 are telecentric, regardless of their focal length. This telecentricity condition, which follows naturally from the geometry of the off-axis reflective objective, is essentially non-existent for a comparable, off-the-shelf refractive objective set.

For the geometry of FIGS. 4 and 5, the interchangeable units 42 and 52 may be incorporated into a mechanical structure that can move one unit out of the optical path, and can move another into the optical path. The mechanical structure may optionally be motorized, so that the changing of focal lengths may not require excessive fixturing from an operator of the inspection system.

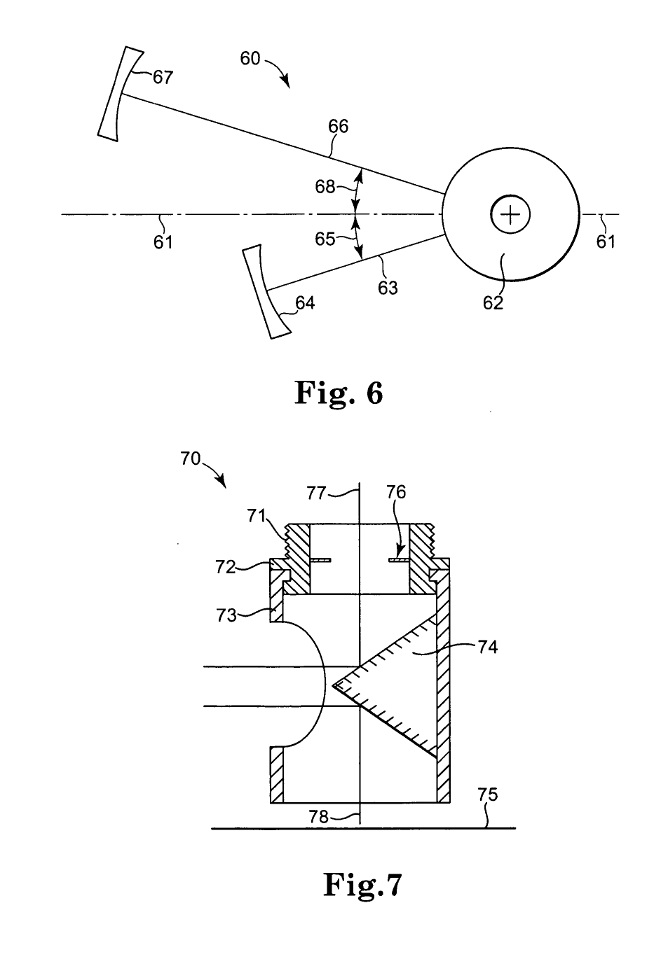

In contrast to the geometry of FIGS. 4 and 5, in which the compound reflector remains stationary and the interchangeable units move, the interchangeable units may reside in a fixed position, and the compound reflector may move to select a particular focal length. For instance, consider the objective 60 of FIG. 6, which can select from one of two focal lengths by either directing a central on-axis ray 63 down the bottom arm to the curved mirror 64, or by directing the central on-axis ray 66 along the top arm to the curved mirror 67. Both the top and bottom arms may also have a compound wedge with the appropriate wedge angles, similar to those in FIG. 3-5.

The actual selecting of one arm versus another may be accomplished by many methods. Two exemplary methods are described in the following paragraphs.

In one method, the compound reflector may be fixed in one particular azimuthal orientation that directs the beam to a first arm, and may be swapped out for another compound reflector having a different azimuthal orientation that directs the beam to another arm. Alternatively, the compound reflector may have multiple reflecting sections, with reflecting angles that may or may not vary with azimuthal position; such a compound reflector could be rotated to another section, or electrically or mechanically altered to vary the arm selection.

Any number of mechanical structures may be used to swap one compound reflector for another. In particular, one exemplary structure may be a turret, such as those typically used for refractive microscope objectives. Each location in the turret may be used to direct the beam down a different arm, with each arm having a different focal length. Optionally, the turret may even mix reflective objectives, such as those in FIGS. 1-5, with standard refractive objectives. In this manner, the reflective objectives can retrofit an existing mount or set of mounts, such as those that are typically used for refractive microscope objectives.

Note that if each compound reflector corresponds only to a single arm, then the geometry of FIGS. 1 and 2 may be used, in which the compound reflector has an angle between the mirrors of greater than 90 degrees, and there is no compound wedge in the arm.

The preferred polarization axis 61 is determined by components in the inspection system that are external to the objective 60; the axis itself is shown in FIG. 6. There are two arms shown, which straddle the preferred polarization axis 61, forming azimuthal angles denoted by element numbers 68 and 65. Although an azimuthal angle of zero may provide optimal performance for one arm, a second arm having a non-zero azimuthal angle may have inadequate performance. As a result, it may be beneficial to compromise both performances by having non-zero azimuthal angles for both arms. Angles 65 and 68 may or may not be equal, depending on the degradation of performance with azimuthal angle, and the desired performance of each arm.

In a second method, the compound reflector (not shown in FIG. 6, but located between the aperture stop 62 and the object) pivots about the central axis of the objective, thereby directing the beam from one azimuthal orientation to another. In this manner, a single compound reflector and a single aperture stop 62 may be used with multiple curved mirrors and may provide multiple focal lengths for the objective 60. For this second method, the compound reflector may have a 90 degree angle between the mirrors, and each arm may have its own compound wedge (not shown in FIG. 6).

This pivoting of the compound reflector about the central axis of the objective may be accomplished by a holder 70, as shown in FIG. 7. A threaded portion 71 can screw into a suitable mounting receptacle, such as a turret. The holder 70 is screwed in until a shoulder 72 becomes flush with a mounting surface on the turret. These shoulders are common on refractive microscope objectives, and the contact between the shoulder and the turret is generally precise enough to suitably locate the objective in three dimensions, so that only a fine focus adjustment is typically required when switching among objectives. The axial location of the aperture stop 76 is typically near the shoulder 72.

Once the threaded portion 71 and shoulder 72 are screwed firmly into the turret, a rotating portion 73 can rotate about the central axis of the objective, independent of the threaded portion 71 or the shoulder 72. The compound reflector 74 is rigidly attached to the rotating portion 73, so it, too, can rotate about the central axis of the objective, independent of the threaded portion 71 or the shoulder 72. As the compound reflector 74 rotates, the azimuthal angle of the beam changes, so that a rotation may direct the beams 77 and 78 from one arm, such as the upper arm in FIG. 6, to another arm, such as the lower arm in FIG. 6. The switching of arms may be accomplished without a significant lateral adjustment of the object 75, and without a coarse focus adjustment.

In the reflective objective, the aperture stop may be located in the interior of the threaded portion 71, as is typically done with refractive microscope objectives. In this manner, the pupil locations remain essentially unchanged when switching from refractive to reflective objectives. Alternatively, the aperture stop may be located at any other suitable location in the objective, such as the interior of the shoulder. Optimally, the objective is telecentric if the aperture stop is located at the rear focal plane of the curved mirror.

Although two arms are shown in FIG. 6, it will be understood by one of ordinary skill in the art that any number of arms may be used, each with its own azimuthal orientation. Note that an azimuthal angle of (x) generally has the same performance as an azimuthal orientation of (x+180 degrees). Accordingly, if the inspection system has only two arms, they may be both located along the preferred polarization axis 61, on opposite sides of the central axis of the objective.

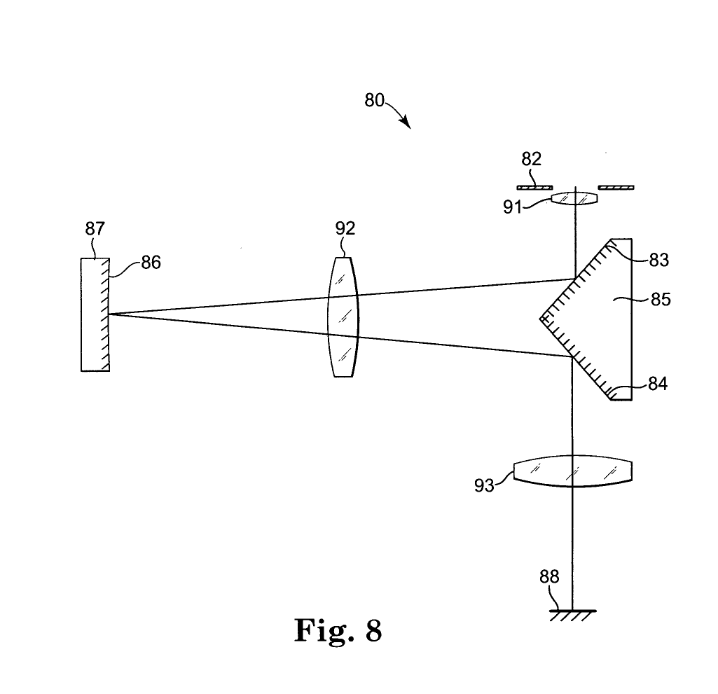

Although the objectives of FIGS. 1 through 7 have essentially all of their optical power in the concave mirrors, it is possible to redistribute some or all of the optical power into additional elements, such as refractive elements. For instance, FIG. 8 shows a catadioptric objective 80, in which optional lenses 91, 92 and 93 may be arranged in a single, double, or complex transmission path. As with the previous figures, the optical path extends from the aperture stop 82, to the reflective surface 83 of compound reflector 85, to the off-axis reflector 87 with reflective surface 86, between to the reflective surface 84 of compound reflector 85, and to the object 88. Any or all of these lenses are optional and may be located anywhere in the optical path.

Although specific embodiments of the present invention have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. An optical apparatus having a rear focal plane and a front focal plane, comprising:
an off-axis reflector; and
a compound reflector for reflecting light from an aperture stop to the off-axis reflector, and for reflecting light from the off-axis reflector to an object plane largely parallel to the aperture stop.

2. The optical apparatus of claim 1, wherein:
the rear focal plane is generally coincident with the aperture stop; and
wherein the front focal plane is generally coincident with the object plane.

3. The optical apparatus of claim 1, wherein:
a central on-axis ray at the aperture stop is generally collinear with a central on-axis ray at the object plane.

4. The optical apparatus of claim 1, wherein:
the off-axis reflector is a concave, front-surface mirror.

5. The optical apparatus of claim 1, wherein:
the compound reflector includes two planar reflectors, formed as adjacent sides of a front-surface reflecting prism.

6. The optical apparatus of claim 5, wherein:
the adjacent sides of the prism form an angle between about 80 degrees and about 100 degrees.

7. The optical apparatus of claim 1, wherein:
the reflections to and from the off-axis reflector are largely parallel to the aperture stop, and are largely perpendicular to a central on-axis ray at the object plane.

8. The optical apparatus of claim 1, wherein:
the reflections to and from the off-axis reflector have an azimuthal orientation that minimizes polarization loss.

9. The optical apparatus of claim 1, further comprising a first refractive element for transmitting light from the aperture stop to the compound reflector.

10. The optical apparatus of claim 9, further comprising a second refractive element for transmitting light from the compound reflector to the off-axis reflector.

11. The optical apparatus of claim 10, further comprising a third refractive element for transmitting light from the off-axis reflector to the object plane.

12. An optical apparatus, comprising:
an optical path from an aperture stop to an object plane largely parallel to the aperture stop; and
a concave reflector having a rear focal plane generally coincident with the aperture stop, and a front focal plane generally coincident with the object plane;
wherein the optical path has a first off-axis reflection between the aperture stop and the concave reflector, and has a second off-axis reflection between the concave reflector and the object plane.

13. The optical apparatus of claim 12, wherein the optical path between the first off-axis reflection and the second off-axis reflection is largely perpendicular to an on-axis central ray in the optical path at the aperture stop and is largely parallel to the object plane.

14. The optical apparatus of claim 13, wherein the optical path between the first off-axis reflection and the second off-axis reflection has an azimuthal orientation that minimizes polarization loss.

15. The optical apparatus of claim 12, wherein an on-axis central ray in the optical path at the aperture stop is generally collinear with an on-axis central ray in the optical path at the object plane.

16. The optical apparatus of claim 12, wherein the optical path strikes the concave reflector off-axis.

17. The optical apparatus of claim 12, wherein the concave reflector is a front-surface, concave mirror.

18. The optical apparatus of claim 12, further comprising a beam-steering element disposed in the optical path adjacent to the concave reflector.

19. The optical apparatus of claim 18, wherein the beam-steering element is a wedge.

20. The optical apparatus of claim 19, wherein the wedge is achromatized.

21. The optical apparatus of claim 18, wherein the beam-steering element and the concave reflector form an interchangeable unit.

22. The optical apparatus of claim 12, further comprising:
a first planar reflector disposed in the optical path between the aperture stop and the concave reflector and forming the first off-axis reflection; and
a second planar reflector disposed in the optical path between the concave reflector and the object plane and forming the second off-axis reflection.

23. The optical apparatus of claim 22, wherein the first and second planar reflectors are formed as adjacent sides of a compound reflector.

24. The optical apparatus of claim 23, wherein the adjacent sides of the compound reflector form an angle between about 80 degrees and about 100 degrees.

25. The optical apparatus of claim 22, further comprising a turret for supporting the first and second planar reflectors.

26. An optical apparatus, comprising:
a first objective, comprising:
a first off-axis reflector; and
a first compound reflector for reflecting light from a first aperture stop to the first off-axis reflector, and for reflecting light from the first off-axis reflector to an object plane largely parallel to the aperture stop; and
a second objective, comprising:
a second off-axis reflector different from the first off-axis reflector; and
a second compound reflector for reflecting light from a second aperture stop to the second off-axis reflector, and for reflecting light from the second off-axis reflector to the object plane;
wherein the first and second objectives are selectable.

27. The optical apparatus of claim 26, wherein the first compound reflector and the second compound reflector are the same.

28. The optical apparatus of claim 26, wherein the first compound reflector and the second compound reflector are different.

29. The optical apparatus of claim 26, wherein:
reflections to and from the first off-axis reflector form a first azimuthal angle, and reflections to and from the second off-axis reflector form a second azimuthal angle; and
wherein the first and second azimuthal angles are both within twenty degrees of an azimuthal orientation that minimizes polarization loss.

30. An optical apparatus, comprising:
a body having a threaded portion concentric with a principal optical axis; and
a compound reflector rotatably mounted to the body for diverting a beam from the principal optical axis and back to the principal optical axis;
wherein the compound reflector is azimuthally adjustable with respect to the threaded portion.

31. The optical apparatus of claim 30, further comprising:
a first concave mirror for reflecting the diverted beam; and
a second concave mirror different from the first concave mirror for reflecting the diverted beam.

32. The optical apparatus of claim 31, further comprising a beam steering element coupled to the compound reflector.

33. The optical apparatus of claim 30, further comprising an aperture stop coupled to the threaded portion.
